(19) United States
(12) Patent Application Publication
(10) Pub. No.: US 2015/0339445 A1
(43) Pub. Date: Nov. 26, 2015

(54) Management of asset utilization

(71) Applicants: Trevor Gruby, Saint Michael, MN (US); Bridget Gruby, Saint Michael, MN (US); Michael Gibbons, Bonaire, GA (US); Marcus Ruark, Austin, TX (US)

(72) Inventors: Trevor Gruby, Saint Michael, MN (US); Bridget Gruby, Saint Michael, MN (US); Michael Gibbons, Bonaire, GA (US); Marcus Ruark, Austin, TX (US)

(21) Appl. No.: 14/717,927

(22) Filed: May 20, 2015

Related U.S. Application Data
(60) Provisional application No. 62/000,947, filed on May 20, 2014.

(51) Int. Cl. G06F 19/00

(52) U.S. Cl. CPC G06F 19/327

(57) ABSTRACT

Methods and systems to improve the utilization of rented and owned equipment by accurately and automatically monitoring equipment utilization rates and making recommendations for desired utilization rates and optimal inventory levels based on statistical analysis of actual utilization rates. By making usage recommendations, embodiments of the present invention allow users of the inventive system to purchase and maintain appropriate quantities of movable assets, proactively manage equipment rental costs, and reduce equipment costs and inventory liability. In a medical environment, these benefits also include improved availability and access to items needed for patient care.

### CROSS-REFERENCE TO RELATED APPLICATIONS

The present application claims the benefit of co-pending U.S. provisional application No. 62/000,947, filed on May 20, 2014, the entire disclosure of which is incorporated by reference as if set forth in its entirety herein.

### FIELD

The invention relates generally to methods and apparatus for asset management, and more specifically to systems that monitor and process asset usage data.

### BACKGROUND

Asset management in hospitals and medical environments is important to efforts to streamline and reduce overall operation costs. Hospitals spend large amounts of funds on various medical supplies and apparatus, but have few options available to track and manage medical and other movable equipment (e.g., IV pumps, ventilators, patient monitors, beds, wheelchairs, carts, laptop computers, etc.).

Similar issues exist in other businesses that rely on the effective use of movable assets. For instance, in a warehouse environment various containers are often moved from one location to another, with some uncertainty arising regarding the present location of a specific container at any given time. As more containers are moved from one location to another, or groups of containers are moved so as to permit access to a specific container, the likelihood of a particular container being misplaced increases.

Accordingly, there is a need for systems and methods that track and manage movable assets, enable improved utilization of these assets, and support efficient operations with optimal equipment inventory levels.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments of the present invention improve the utilization of rented and owned equipment by accurately and automatically monitoring equipment utilization rates and making recommendations for desired utilization rates and optimal inventory levels based on statistical analysis of actual utilization rates. By making usage recommendations, embodiments of the present invention allow users of the inventive system to purchase and maintain appropriate quantities of movable assets, proactively manage equipment rental costs, and reduce equipment costs and inventory liability. In a medical environment, these benefits also include improved availability and access to items needed for patient care.

In one aspect, embodiments of the present invention relate to system for managing asset utilization. The system includes a collector, a memory, a processor, and an interface. The collector receives data concerning the usage of a plurality of assets. The memory is configured to store the received data concerning the usage of the plurality of assets. The processor is configured to analyze the usage data of the plurality of assets. The interface is configured to transmit a recommendation concerning the plurality of assets based on the analysis of the usage data.

In one embodiment, the processor is further configured to assign a category to at least one of the plurality of assets. In one embodiment, the processor configured to analyze the usage data of the plurality of assets is configured to analyze the schedule and duration of the usage of at least one asset. In one embodiment, the processor configured to analyze the usage data of the plurality of assets is configured to determine a usage rate for at least one asset.

In one embodiment, the processor configured to analyze the usage data of the plurality of assets is configured to determine a peak usage rate for at least a subset of the plurality of assets. The interface may be further configured to receive a desired usage rate, and the recommendation conforms the determined usage rate to the desired usage rate. The interface may be further configured to receive a desired variance value, and the recommendation is in accord with the desired variance value.

In one embodiment, the interface is further configured to receive a definition of the plurality of assets. In one embodiment, the interface is further configured to provide a display of the analyzed usage data substantially contemporaneously with the receipt of the data. In one embodiment, the interface is further configured to display at least one report resulting from the analysis of the usage data. In one embodiment, the processor configured to analyze the usage data of the plurality of assets is configured to determine a standard deviation bell curve for usage rates based upon temporal utilization data for at least a subset of the plurality of assets.

In another aspect, embodiments of the present invention relate to a method for managing asset utilization. The method includes receiving data concerning the usage of a plurality of assets, analyzing the usage data of the plurality of assets, and making a recommendation concerning the plurality of assets based on the analysis of the usage data.

In one embodiment, the method further includes assigning a category to at least one of the plurality of assets. In one embodiment, analyzing the usage data of the plurality of assets comprises analyzing the schedule and duration of the usage of at least one asset. In one embodiment, analyzing the usage data of the plurality of assets includes determining a usage rate for at least one asset.

In one embodiment, analyzing the usage data of the plurality of assets includes determining a peak usage rate for at least a subset of the plurality of assets. The method may further include receiving a desired usage rate and the recommendation conforms the determined usage rate to the desired usage rate. The method may further include receiving a desired variance value and the recommendation is in accord with the desired variance value.

In one embodiment, the method further includes receiving a definition of the plurality of assets. In one embodiment, the method further includes providing a display of the analyzed usage data substantially contemporaneously with the receipt of the data. In one embodiment, the method further includes displaying at least one report resulting from the analysis of the usage data.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a flowchart of an exemplary method for managing asset utilization in accord with the present invention;

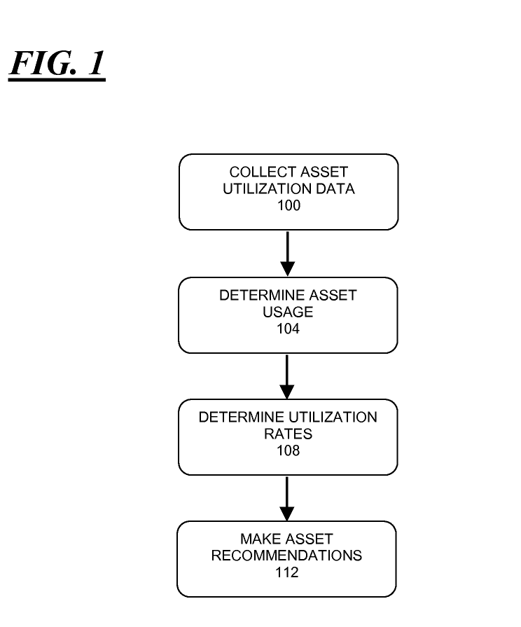

FIG. 2 presents the operation of an exemplary embodiment of the present invention as it analyzes asset utilization data;

FIG. 3 illustrates the operation of the embodiment of FIG. 2 as it analyzes utilization rates in comparison with daily census figures;

FIG. 4 depicts the operation of the embodiment of FIG. 2 as it analyzes asset utilization rates; and

FIG. 5 is a block diagram of an exemplary apparatus for managing asset utilization in accord with the present invention.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Embodiments of the present invention include methods and systems to manage and improve asset utilization. Such embodiments are generally useful in environments that utilize movable assets in the course of business, and for illustrative and exemplary purposes the following discussion assumes an embodiment utilized in a medical facility. However, one of ordinary skill would understand that embodiments of the present invention are not limited to such environments.

In one embodiment, the process begins with the collection of data from at least one asset that can be interpreted as the asset being “in use” or “not in use” (Step 100). The data may be collected directly using, for example, RFID tags, beacons, or transmitters mounted on an asset of interest that relay or otherwise indicate usage information for the asset, or indirectly using an interface to a source of data that may be analyzed to yield asset usage information (e.g., a collection of location data, a communication log, records of power consumption, etc.).

Exemplary signals indicative of equipment usage can be movements of equipment into and out of a patient's assigned room, an indication from the device itself indicating it is in use such as administering medication or venting air, or a manual indication of use, e.g., because nursing staff are operating the device's interface. These signals can, in turn, be used to classify an asset as, e.g., available, in use, dirty, being cleaned, needs maintenance, etc. These classifications can be useful for various purposes, but for asset utilization purposes these various states can be reduced to a determination that the asset is “in use” or “not in use.” For example, in one embodiment, an asset can be classified as “in use” if its status is anything other than “available.”

Once collected, the data can be interpreted to determine whether the asset is in use and, if so, for how long and at what time (Step 104). In some embodiments, the interpretation of the collected data can be performed substantially contemporaneously with its collection. In other embodiments, the collected data is processed offline after its collection.

For example, a positioning system may provide data indicating that an asset is in motion which can serve as a basis for the determination that the asset is in use. A record of network communications originating with the asset may also serve as a basis for a determination that the asset is in use. Similarly, records of electrical power consumed by the asset may also serve as a basis for a determination that the asset is in use.

Having determined the usage of the assets from the collected data, the usage data may be used by itself or in combination with some or all of the collected data to determine a utilization rate for each asset (Step 108), such as the ratio between the number of assets available for use/already in use and the total number of assets, or the raw number of assets in use or not in use at any given time or during any given period of time. In various embodiments the usage rate may be calculated with various levels of granularity. For example, the usage rate may be calculated as a function of time or location, or for a particular span of time or particular location.

In certain embodiments, a peak utilization rate can be determined for a group or fleet of assets. The peak utilization rate is typically defined as the point in time when the most assets in the fleet are in use. For example, if during the hour between 1 and 2 p.m., at 1:04 p.m. 134 IV pumps were determined to be “in use,” and that was the maximum number of IV pumps in use for that hour for any minute of that hour, then 134 would be the peak utilization for that asset group in that timeframe. Peak utilization may be calculated for various classes of equipment at regular intervals, e.g., each hour, and optionally for various locations, e.g., each floor of a facility.

The computation of utilization rates can be done in real time or near real time, contemporaneously with the collection of data, or it may be performed offline, i.e., after the data has been collected, allowing for the computation of various statistical measures for an arbitrary group of assets selected from the general asset pool by a user. Embodiments of the invention allow for the definition of asset groups in connection with the data collection process, allowing for the computation of measures and the monitoring of utilization rates (mean, peak and otherwise) in real time.

With data for some or all of these metrics, embodiments of the present invention can make recommendations concerning asset utilization and deployment to enable improved usage of individual assets and groups of assets (Step 112). For example, statistical analysis can be performed to identify the mean and standard deviation of the utilization rate for a defined group of assets to identify, e.g., the mean number of assets unavailable for use.

Embodiments of the present invention allow for the manual or automatic specification of a desired utilization rate with respect to a particular group of assets, and in turn provides a recommendation concerning the acquisition or disposition of assets with respect to the group in order to achieve the desired utilization rate.

The desired utilization rate may be specified as a definite numerical value or relative to one or more other values. For example, a desired utilization rate may be specified in terms of the number of standard deviations away from the mean utilization rate for a particular group of assets, a particular time line, a particular region, etc. Note that the desired utilization rate is a result of determining the optimal inventory level, which may be specified in terms of the number of standard deviations away from the mean usage level for a particular group of assets.

The specified variance can be chosen manually or automatically based on, e.g., business needs and the operator's willingness to bear the risk that the business may be forced to operate with insufficient assets if the actual utilization rate exceeds what was expected based on past usage and the specified variance. In accord with the invention, various reports can be generated and displayed concerning individual assets, asset pools, utilization rates, mean utilization rates, peak utilization rates, utilization rate statistics, etc.

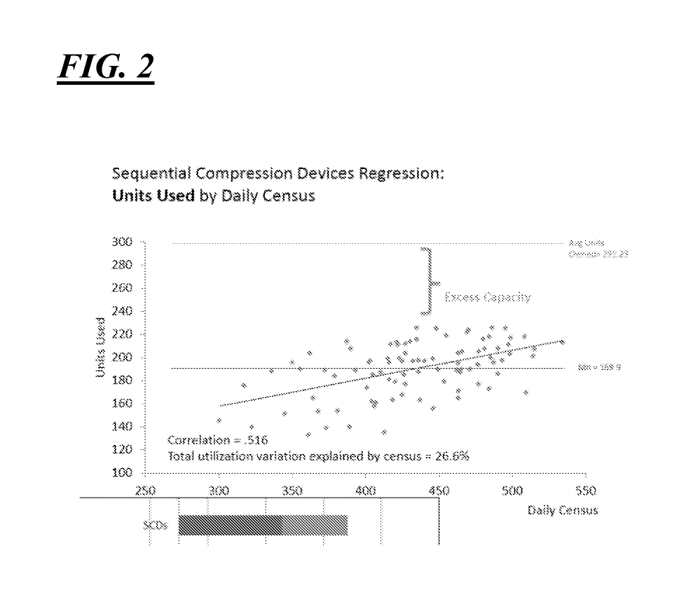

FIGS. 2-4 depict the operation of an exemplary embodiment of the present invention with respect to a pool of sequential compression assets in a medical environment. The embodiment collects data concerning the utilization of the sequential compression assets (Step 100)—their stage of usage, their duration of usage, their time of usage, etc.

FIG. 2 presents the collected sequential compression asset usage data plotted against the number of patients seen in a given day in the facility housing the assets; this latter figure is typically obtained from a separate system tracking patients. As can be seen from FIG. 2, the number of compression assets utilized in a given day varies directly with the number of patients seen each day. However, in no event does the number of sequential compression devices used ever exceed approximately 230 devices. Given that approximately 292 units are owned by the facility, and assuming that future utilization rates of the compression assets fall in line with historical usage patterns, analysis suggests approximately 60 surplus units and the system recommends an appropriate reduction.

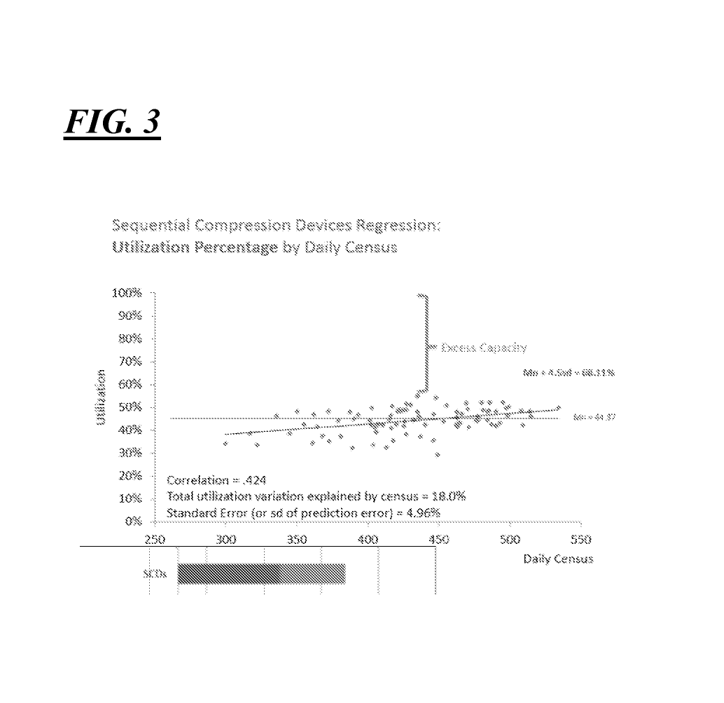

FIG. 3 presents the same data as FIG. 2, but with the utilization rate percentage plotted against the number of patients seen in lieu of the raw number of assets utilized. In this view, it is clear that the utilization rate is relatively stable, with 35-45% of the sequential compression assets being used on a typical day. In fact, when the utilization rates are analyzed statistically, as discussed below, 68.11% of the assets would be the recommended inventory level set at 4.5 standard deviations away from the mean. Accordingly, the system can recommend the disposal of 32% of the assets and still ensure that the remaining asset base will meet the clinic's needs in all but the most extreme situations.

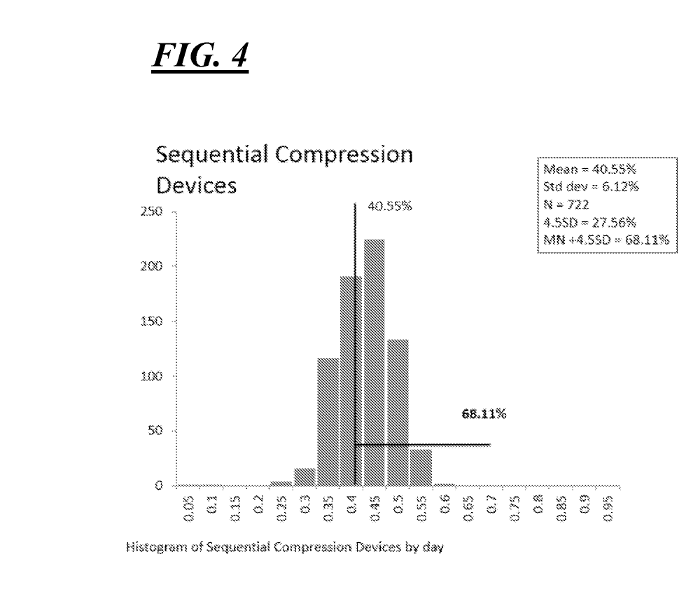

FIG. 4 presents the usage rate data of FIGS. 2 and 3 plotted as a histogram which, as expected, falls in a bell curve centered on a mean utilization rate of 40.55%. As discussed above, 4.5 standard deviations away from the mean is 27.56% and, accordingly, the recommended inventory level would be 68.11% of the current inventory level of sequential compression devices.

Assuming that the operator is risk intolerant, i.e., such that they would want to have sufficient equipment on hand to account for extremely high and unlikely usage rates, and choosing a variance of 4.5 standard deviations to account for this risk intolerance, reveals that some 30% of the asset pool is surplus inventory which can be retired or otherwise sold.

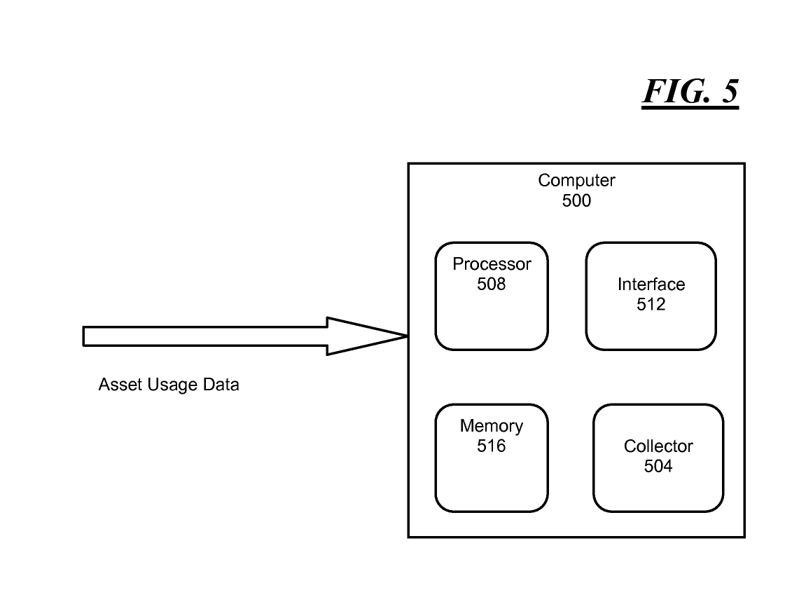

FIG. 5 presents an example of a system for managing asset utilization in accord with the present invention. The computer 500 may be a dedicated device such as a server or desktop computer containing one or more of the components depicted in FIG. 5; a general purpose device such as a tablet, phablet, etc., running a program that collects data concerning user activity as discussed herein; or a hosted service such as a cloud-based virtual machine executing one or more programs providing the functionality described above.

The collector 504 allows the system 500 to receive various forms of asset usage data, both direct and indirect as discussed above, providing the data to the processor 508 for display via the interface 512 and/or storage in the memory 516. The collector 504 typically interacts with one or more assets or sources of asset usage data via a network interface such as gigabit Ethernet, Wi-Fi (802.11a/b/g/n), Bluetooth, and/or 3G/4G wireless interfaces such as GSM/WCDMA/LTE that enable data transmissions between system 500 and other devices and data sources.

The processor 508 is configured to analyze the usage data received via the collector 504, generating various statistical measures of usage for one or more groups of assets and recommendations concerning asset acquisition, disposition, and deployment as discussed above. A typical processor 504 is an x86, x86-64, or ARMv7 processor, and the like.

The interface 512 allows the system 500 to receive commands from and/or provide feedback to the user; particular forms of feedback in accord with the present invention include various statistical measures of asset usage and recommendations concerning one or more assets, i.e., assets to acquire, assets to dispose of, etc., in order to ensure that regular business operations stay within various specified parameters. Exemplary interfaces 512 include graphical displays, physical keyboards, virtual keyboards, etc.

The memory 516 provides both transient and persistent storage for data received via the collector 504, data processed by the processor 508, and data received or sent via the interface 512. The memory 516 may, in various embodiments, be a hard drive, solid-state drive, a volatile memory, etc.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A system for managing asset utilization, the system comprising:
a collector for receiving data concerning the usage of a plurality of assets;
a memory configured to store the received data concerning the usage of the plurality of assets;
a processor configured to analyze the usage data of the plurality of assets; and
an interface configured to transmit a recommendation concerning the plurality of assets based on the analysis of the usage data.

2. The system of claim 1, wherein the processor is further configured to assign a category to at least one of the plurality of assets.

3. The system of claim 1, wherein the processor configured to analyze the usage data of the plurality of assets is configured to analyze the schedule and duration of the usage of at least one asset.

4. The system of claim 1, wherein the processor configured to analyze the usage data of the plurality of assets is configured to determine a usage rate for at least one asset.

5. The system of claim 1, wherein the processor configured to analyze the usage data of the plurality of assets is configured to determine a peak usage rate for at least a subset of the plurality of assets.

6. The system of claim 4, wherein the interface is further configured to receive a desired usage rate, and the recommendation conforms the determined usage rate to the desired usage rate.

7. The system of claim 6, wherein the interface is further configured to receive a desired variance value, and the recommendation is in accord with the desired variance value.

8. The system of claim 1, wherein the interface is further configured to receive a definition of the plurality of assets.

9. The system of claim 1, wherein the interface is further configured to provide a display of the analyzed usage data substantially contemporaneously with the receipt of the data.

10. The system of claim 1, wherein the interface is further configured to display at least one report resulting from the analysis of the usage data.

11. The system of claim 1, wherein the processor configured to analyze the usage data of the plurality of assets is configured to determine a standard deviation bell curve for usage rates based upon temporal utilization data for at least a subset of the plurality of assets.

12. A method for managing asset utilization, the method comprising:
receiving data concerning the usage of a plurality of assets;
analyzing the usage data of the plurality of assets; and
making a recommendation concerning the plurality of assets based on the analysis of the usage data.

13. The method of claim 12 further comprising assigning a category to at least one of the plurality of assets.

14. The method of claim 12 wherein analyzing the usage data of the plurality of assets comprises analyzing the schedule and duration of the usage of at least one asset.

15. The method of claim 12 wherein analyzing the usage data of the plurality of assets comprises determining a usage rate for at least one asset.

16. The method of claim 12 wherein analyzing the usage data of the plurality of assets comprises determining a peak usage rate for at least a subset of the plurality of assets.

17. The method of claim 15 further comprising receiving a desired usage rate and the recommendation conforms the determined usage rate to the desired usage rate.

18. The method of claim 17 further comprising receiving a desired variance value and the recommendation is in accord with the desired variance value.

19. The method of claim 12 further comprising receiving a definition of the plurality of assets.

20. The method of claim 12 further comprising providing a display of the analyzed usage data substantially contemporaneously with the receipt of the data.

21. The method of claim 12 further comprising displaying at least one report resulting from the analysis of the usage data.
